(19) United States
(12) Patent Application Publication
(10) Pub. No.: US 2016/0366172 A1
(43) Pub. Date: Dec. 15, 2016

(54) PREVENTION OF CROSS SITE REQUEST FORGERY ATTACKS

(71) Applicant: ARRIS Enterprises LLC, Suwanee, GA (US)

(72) Inventors: Girdhari Lal Yadav, Rajasthan (IN); Sabarinathan Nagarajan, Bangalore (IN); Bijoy Kaippilly, Bangalore (IN); Asheesh Jagdish Joshi, Bangalore (IN)

(21) Appl. No.: 15/180,692

(22) Filed: Jun. 13, 2016

Related U.S. Application Data
(60) Provisional application No. 62/174,825, filed on Jun. 12, 2015.

(51) Int. Cl. H04L 29/06

(52) U.S. Cl. CPC H04L 63/1425; H04L 63/1466

(57) ABSTRACT

A method is provided for preventing cross-site request forgery (CSRF) attacks at a server that includes embedding a hidden cryptographic nonce in a response from a server to a client that is authorized to access the server. The response with the hidden cryptographic nonce is sent to the client. A subsequent request is received from the client. The subsequent request is validated or otherwise verified if it includes a hidden cryptographic nonce that matches the hidden cryptographic nonce embedded in the response from the server.

### STATEMENT OF RELATED APPLICATION

This application claims the benefit of U.S. Provisional Application No. 62/174,825, as filed on Jun. 12, 2015, the contents of which are incorporated herein by reference.

### BACKGROUND

Cross-site request forgery (“CSRF”), which is sometimes referred to as a one-click attack or session riding, is a type of computer attack in which an attacker attempts to perform actions on behalf of an authenticated user without the knowledge of the authenticated user. The attack generally involves creating malicious web content that is placed in an email or on an otherwise legitimate website. When a victim browses the malicious web content, the victim's browser is caused to issue an attacker-controlled request to a target third-party website. If the victim is authenticated to the target website, the request will be sent with the browser's cookies or other authentication. Having the victim's authentication in place, the malicious code can execute undesirable actions on behalf of the victim at the target website. These undesirable actions may be carried out without the victim's consent. As examples, where the target website is a blog system or an email system, the undesirable actions could include deleting or modifying a blog, or adding an email-forwarding rule. As another example, if the target web service is a bank, the undesirable action may be the unauthorized transfer of funds to the attacker's account.

FIG. 1 is a flow diagram schematically illustrating an example of a CSRF attack. As indicated by arrow 161, the CSRF attack may begin with a hacker or other malicious individual introducing CSRF code in a legitimate website 170 that the victim visits. The CSRF code may comprise computer program code that automatically performs unauthorized access to a target website upon receipt and execution in the victim's computer. As indicated by arrow 162, the victim, employing a web browser 173, may request a web page from the legitimate website 170. In response, the website 170 provides the web page (indicated by arrow 163), which may include the CSRF code. When the CSRF code is received and executed in the victim's computer, the CSRF code sends unauthorized transmissions to access the victim's online account in the target third party website 171 (indicated by arrow 164). For example, the CSRF code may comprise the following script:

<Img src=http://thirdpartywebsite.com/unauthorizedaction.asp?amnt=10000&acc=someone&-gt;
where “thirdpartywebsite.com” is the domain of the website 171. If the user keeps authentication information for the target website 171 in a cookie, for instance, and if the cookie has not expired, the script will perform an unauthorized action (e.g., transfer funds, disable or otherwise change security settings) without the victim's approval when the script is executed in the victim's computer.

### SUMMARY

In accordance with one aspect of the invention, a method is provided for preventing cross-site request forgery (CSRF) attacks at a server. In accordance with the method, a hidden cryptographic nonce is embedded in a response from a server to a client that is authorized to access the server. The response with the hidden cryptographic nonce is sent to the client. A subsequent request is received from the client. The subsequent request is validated or otherwise verified if it includes a hidden cryptographic nonce that matches the hidden cryptographic nonce embedded in the response from the server.

In one particular implementation, the response from the server to the client includes a resource in which the cryptographic nonce is hidden. In one example, the resource may be a form such as an HTML form that is returned by the client to the server after its fields are populated with user-specific information.

### BRIEF DESCRIPTION OF THE DRAWINGS

FIG. 1 is a flow diagram schematically illustrating an example of a CSRF attack.

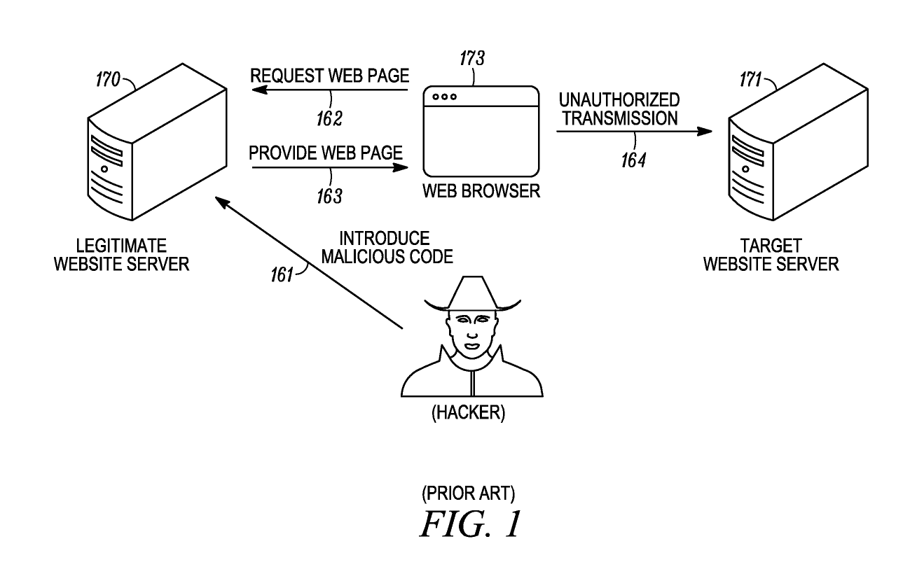

FIG. 2 is a diagram illustrating an example of a client-server environment in which a user accesses the administrative control web page of a gateway used to access the Internet.

FIG. 3 shows a user screen with an example of an administrative control form that is used to specify the Dynamic Domain Name System (DDNS) settings of a gateway.

FIG. 4 is a message flow diagram illustrating one example of a method for preventing CSRF attacks by adding a hidden nonce to HTML forms or other resources requested by a client from a server.

FIG. 5 shows various components of an illustrative computing-based device in which embodiments of a server and/or a client as described herein may be implemented.

### DETAILED DESCRIPTION

As detailed below, in one aspect a system and method is shown for preventing cross-site request forgery (“CSRF”) attacks by embedding cryptographic nonces in hidden fields of resources that are provided to clients by a server and subsequently returned by the clients to the server. While the techniques described herein are generally applicable to CSRF attacks on servers that provide any type of service, including without limitation, banking, social media, email and security (e.g., firewall) services, for purposes of illustration the target server will described as a server that controls the functionality of a gateway such as a cable modem. The CSRF attack may target, for example, the administrative control page hosted on the server, which controls various setting of the gateway. An attacker may perform a CSRF attack on this server to change the username, password, DDNS service and/or the host name of the user's account without the user's knowledge in order to exploit the functionality offered by the gateway.

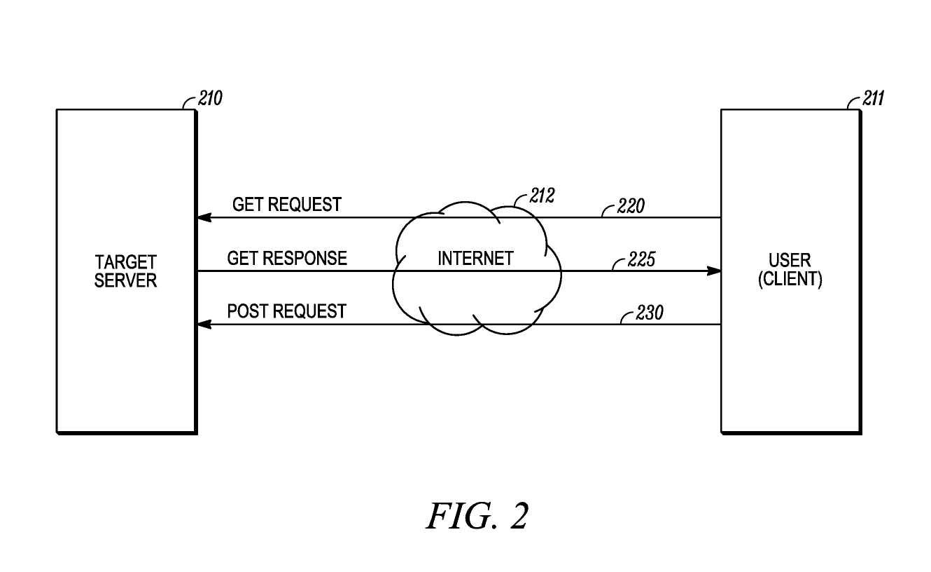

FIG. 2 is a diagram illustrating an example of a client-server environment in which a subscriber (the user) accesses the administrative control web page of a gateway (e.g., a cable modem) used to access the Internet. The administrative control web page is hosted by the target server 210. The user accesses the web page through a network such as the Internet 212 from a client device 211 such as a personal computer, wireless mobile device (e.g., smartphone), tablet, entertainment devices such as a video game console, consumer electronic device or the like, which generally runs a web browser application on top of the device's operating system. It is assumed that the user has already been authorized (using, e.g., a username and password) to access the administrative control web page.

It should be noted that while the network depicted in FIG. 2 is illustrated as the Internet 212, more generally it may be any type of network whether wired, wireless or any combination thereof. For example, the network may be a wide area network (WAN) such as the aforementioned Internet or an intranet. As another example, network 212 may be a cellular network (e.g., 3G, CDMA). In yet another example, network 212 may be a content delivery system such as a broadcast television network, cable data network (e.g. an all-coaxial or a hybrid-fiber/coax (HFC) network), an xDSL (e.g., ADSL, ADLS2, ADSL2+, VDSL, and VDSL2) system, or a satellite television network. In yet other examples the network 212 may be a combination of two or more different types of networks.

For purposes of illustration the messages exchanged between the server and client will be described in terms of the request/response protocol of HTTP. However, the techniques described herein are not limited to the use of the HTTP protocol but more generally may employ other transfer protocols in a similar manner to send and receive messages.

As shown by the transactions 220, 225 and 230, the client 211 first sends a request 220 to the target server 210 to access a resource on the administrative control page with the HTTP GET Request command. Although the techniques described herein are applicable to a wide range of resources, in one particular embodiment the resource is an administrative control form that contains relevant fields in which the user can specify various settings for the gateway. The server 210 then returns a response 225 using the HTTP GET Response command, which includes the administrative control form. The user next enters the required information on the form and sends it back at 230 using the POST Request command.

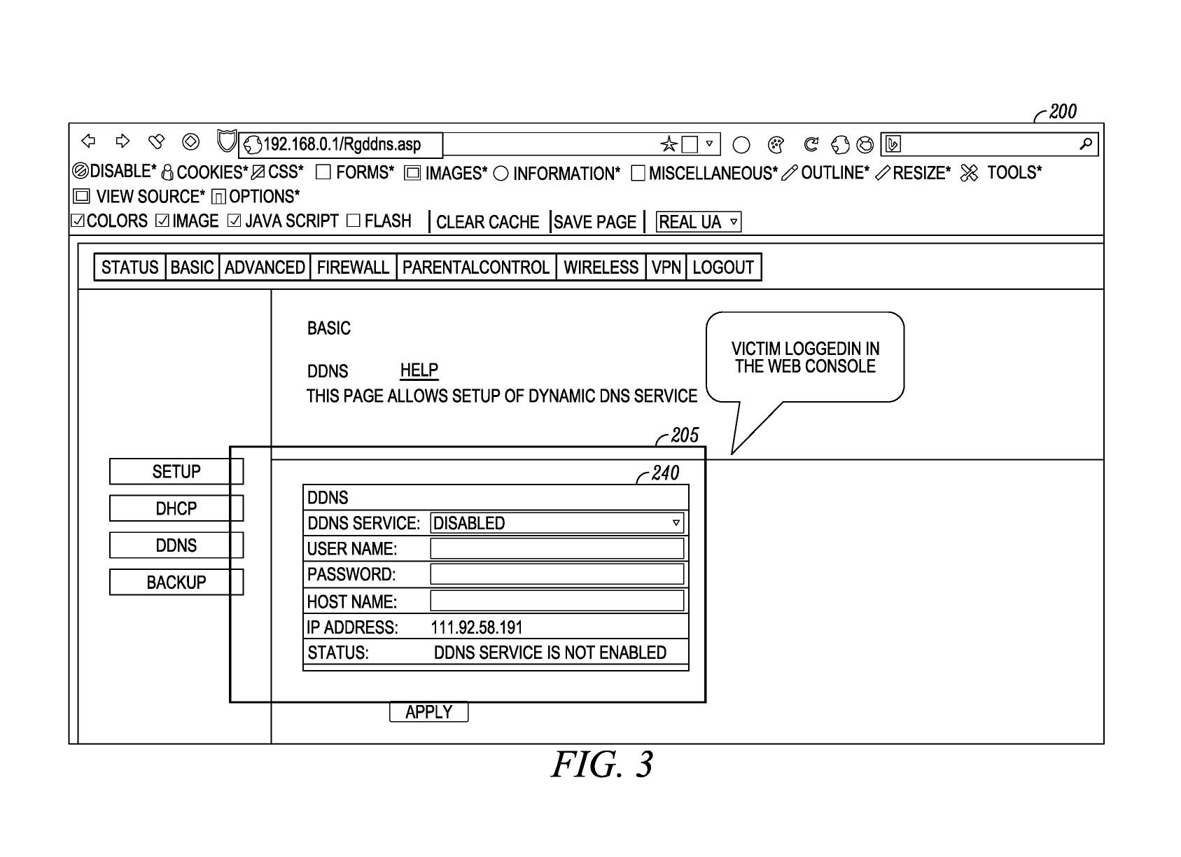

FIG. 3 shows a user screen 200 with an example of an administrative control form 205 that is used to specify the Dynamic Domain Name System (DDNS) settings of the gateway. The form 205 includes fields 240 in which the user can provide requested information such as the DDNS service to be used, the user name and password, and so on. After the user completes the form and selects the “apply” icon, the form is sent from the client device 211 to the target server 210. Other administrative control pages may contain similar forms to control other settings of the gateway.

In order to initiate a CSRF attack, the attacker will generally cause a virus script to be installed in the user's web browser. The script may be placed at a location the user is likely to visit while logged into the target server. For instance, the virus script may be included in an email body or attachment or it may be included on a website that the user may visit. In particular, the CSRF attack may be executed, for example, by using a Hypertext Markup Language (HTML) image tag, or JavaScript image object. Typically, an attacker will embed an image tag or object into the email or website so that when the user loads the web page or email, it performs a web request to the target website. That is, the virus script causes the web browser to send unauthorized commands to the target server in which the user has already logged in or otherwise established a session. In this way the attacker can cause the server to perform an action on behalf of the attacker using the user's own client device. In the current example the unauthorized command transmits a forged administrative control form of the type shown in FIG. 3. An example of such a form that can be used to supply incorrect information of the type requested in the fields of FIG. 3 is shown below:

<html>
<body>
<form action=http://192.168.100.1/goform/RgDdns.pl method=POST
name=″Ddns″>
<input type=″hidden″ name=”DdnsService” value=”1”>
<input type=″hidden″ name=″DdnsUserName″ value=″test1″>
<input type=″hidden″ name=″DdnsPassword″ value=″text1″>
<input type=″hidden″ name=″DdnsHostName″ value=″text2″>
<input type=″submit″ value=″click here″ align=″middle″>

</body>

In the example shown above the user-specified fields in the form such as the fields for a user name, password and DDNS host name are filled by the forged values “test1”, “text1” and “text2”, respectively.

In accordance with one aspect of the techniques described herein, a CSRF attack may be prevented, or its likelihood of success reduced, by embedding additional information into the forms or other resources that are sent to the client device. The additional information may be a cryptographic nonce such as a random or pseudo-random number or set of alphanumeric characters. The nonce may be placed in a hidden field in the forms, pages, and/or other resources provided by the server to the client. When the user posts the request to the server with the information required by the form, the server examines the request. If the nonce is not included, or if there is a mismatch between the nonce included in the server's response and the client's request, the server will conclude that the request is in fact not authorized by the user and it will ignore the request. That is, the request will not be processed and, in some cases, the user may be returned to the login page. Only if the correct nonce is submitted to the server by the client will the client request be processed.

By way of example, the hidden field that includes the nonce may be as follows:

<table><tr><td><input type=“hidden” name=“GetNonce” size=31 value=XgNO0xivhm6swBpX59HohcISLNKIHqe></td></tr></table>

In some embodiments the value of the nonce that is generated will be valid for the duration of a session between the client and the server. That is, the same nonce may be used for all requests posted by the client during a single session. If the user logs out and subsequently logs in to initiate a new session, a new nonce will be generated by the server and the previous nonce will no longer be valid.

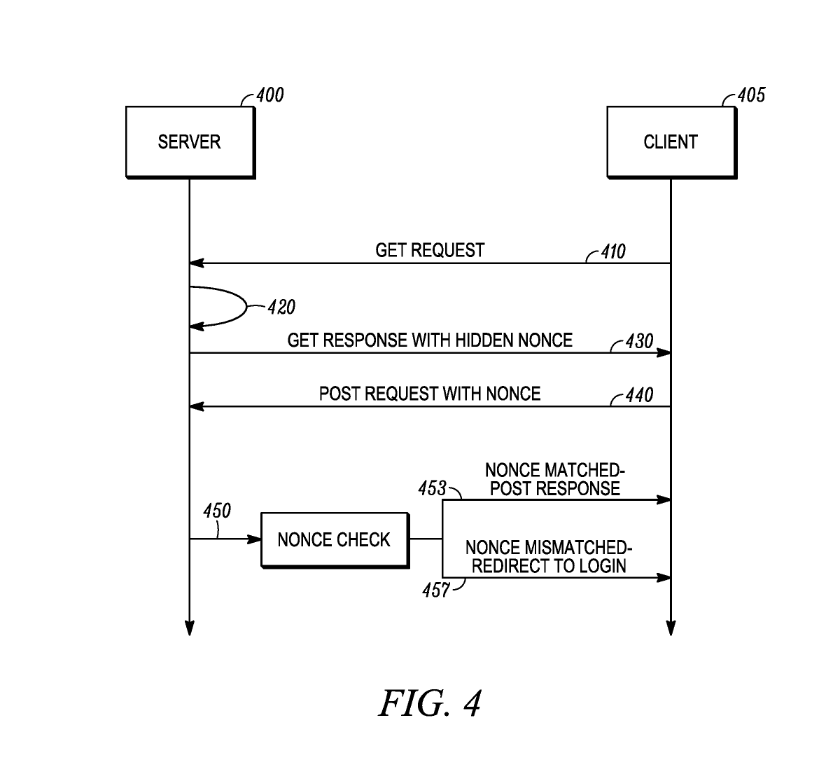

FIG. 4 is a message flow diagram illustrating one example of a method for preventing CSRF attacks by adding a hidden nonce to HTML forms or other resources requested by a client from a server. The method begins in step 410 when, after the client has been authorized to access the server by performing a login process or the like, the client sends a Get Request to the server to retrieve a resource from the server such as an HTML form. In response to the receipt of the Get Request, the server generates a nonce such as a set of random or pseudo-random alphanumeric characters in step 420 and embeds the nonce as a hidden field of the requested resource. Next, in step 430 the server sends a Get Response to the client that includes the requested resource with the hidden nonce. The client subsequently returns the resource to the server using a POST Request in step 440 after performing any suitable action(s). For instance, if the resource is an HTML form, the client provides the requested information in the various fields of the form. After receiving the resource, the server examines the nonce (if present) contained in the resource in step 450. If the nonce in the returned resource matches the nonce included in the resource provided by the server, the server will process the client request in step 453. If on the other hand the nonce is not present in the returned resource, or if it does not match the nonce included in the resource provided by the server, the server denies to process the request in step 457 and may optionally redirect the client to the login page.

While in the example described in connection with FIG. 4 the hidden nonce is embedded in HTML forms, more generally the hidden nonce may be embedded in forms that are structured and formatted using other markup languages. In addition, the example above assumes that the client is already authorized to access the server prior to the initiation of the CSRF attack. However, in some cases this restriction may not be necessary because the attacker may have access to the authorization credentials such as a username and password. For instance, this may be the case when the server is associated with a device such as a customer-premises gateway, which is typically provided to the user with a default username and password. If the user does not change these authorization credentials, the attacker may be able to access them since they are widely disseminated to customers.

Aspects of the subject matter described herein are operational with numerous general purpose or special purpose computing system environments or configurations that employ dual or multi-core processors. Examples of well-known computing systems, environments, or configurations that may be suitable for use with aspects of the subject matter described herein comprise personal computers, server computers, hand-held or laptop devices, multiprocessor systems, microcontroller-based systems, set-top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules or components, being executed by a computer. Generally, program modules or components include routines, programs, objects, data structures, and so forth, which perform particular tasks or implement particular data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

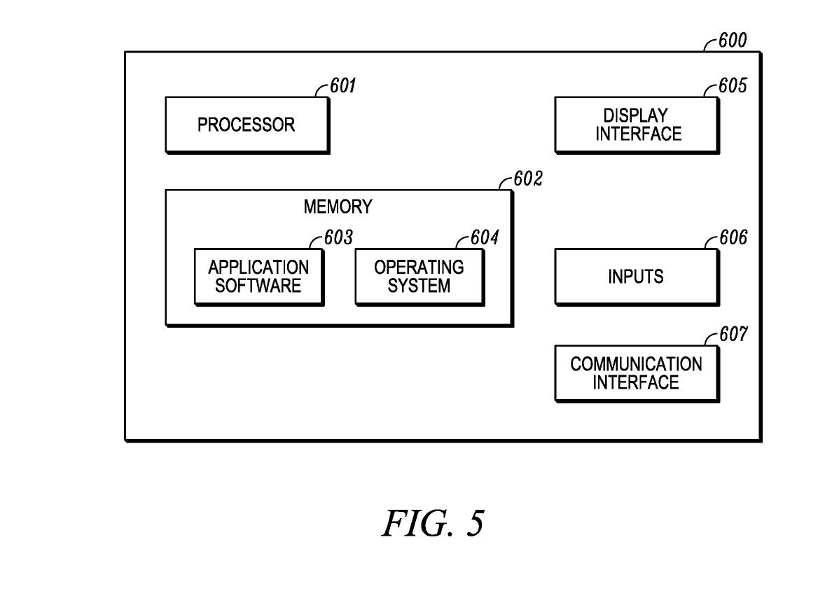

FIG. 5 illustrates various components of an illustrative computing-based device 600 which may be implemented as any form of a computing and/or electronic device, and in which embodiments of a server and/or a client as described above may be implemented.

The computing-based device 600 comprises one or more inputs 606 which are of any suitable type for receiving media content, Internet Protocol (IP) input, activity tags, activity state information, resources or other input. The device also comprises communication interface 607 to enable the device to communicate with one or more other entity using any suitable communications medium.

Computing-based device 600 also comprises one or more dual or multi-core processors 601 which may be microprocessors, controllers or any other suitable type of processors for processing computing executable instructions to control the operation of the device in order to decode video streams. Platform software comprising an operating system 604 or any other suitable platform software may be provided at the computing-based device to enable application software 603 to be executed on the device.

The computer executable instructions may be provided using any computer-readable media, such as memory 602. The memory is of any suitable type such as random access memory (RAM), a disk storage device of any type such as a magnetic or optical storage device, a hard disk drive, or a CD, DVD or other disc drive. Flash memory, EPROM or EEPROM may also be used.

An output is also provided such as an audio and/or video output to a display system integral with or in communication with the computing-based device. A display interface 605 is provided to control a display device to be used in conjunction with the computing device. The display system may provide a graphical user interface, or other user interface of any suitable type.

As disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readablge storage media for storing information. The term “computer-readable storage medium” includes, but is not limited to, portable or fixed storage devices, optical storage devices, a SIM card, other smart cards, and various other mediums capable of storing, containing, or carrying instructions or data. However, computer readable storage media do not include transitory forms of storage such as propagating signals, for example.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable storage medium and executed by one or more processors.

Although the subject matter has been described in language specific to structural features and/or methodological acts, it is to be understood that the subject matter defined in the appended claims is not necessarily limited to the specific features or acts described above. Rather, the specific features and acts described are disclosed as example forms of implementing the claims.

1. A method for preventing cross-site request forgery (CSRF) attacks at a server, comprising:
embedding a hidden cryptographic nonce in a response from a server to a client that is authorized to access the server;
sending the response with the hidden cryptographic nonce to the client;
receiving a subsequent request from the client; and
verifying if the subsequent request received from the client includes a hidden cryptographic nonce that matches the hidden cryptographic nonce embedded in the response from the server.

2. The method of claim 1, further comprising denying to process the subsequent request if the match is not verified.

3. The method of claim 1, further comprising processing the subsequent request only if the match is verified.

4. The method of claim 1, wherein the response includes a resource in which the cryptographic nonce is hidden.

5. The method of claim 4, wherein the resource is a form expressed in a markup language having fields to be populated by a user.

6. The method of claim 5, wherein the form is an HTML form.

7. The method of claim 5, wherein the verifying further comprises verifying if the subsequent request received from the client includes the form with a hidden cryptographic nonce that matches the hidden cryptographic nonce.

8. The method of claim 1, further comprising generating the hidden cryptographic nonce to be embedded in the response.

9. The method of claim 8, further comprising randomly or pseudo-randomly generating the hidden cryptographic nonce.

10. The method of claim 8, wherein the hidden cryptographic nonce that is generated is valid only during a single session between the server and the client.

11. The method of claim 1, wherein the request and the subsequent request is received from a client browser.

12. The method of claim 1, wherein sending the response with the hidden cryptographic nonce includes sending the response while the client is in a secure session with the server.

13. At least one computer-readable storage medium encoded with instructions, which when executed by a processor, performs a method for securing against cross-site request forgery (CSRF), comprising:
receiving a request from a client browser during a secure session with a server;
analyzing the request to determine if a hidden cryptographic nonce is present therein and matches a previously generated cryptographic nonce previously sent to the client; and
fulfilling the request only if the hidden cryptographic nonce is present therein and matches the previously generated cryptographic nonce.

14. The at least one computer-readable storage medium of claim 13, further comprising sending the previously generated cryptographic nonce during the secure session.

15. The at least one computer-readable storage medium of claim 13, wherein the request from the client includes a form previously sent to the client during the secure session, the cryptographic nonce being embedded in a hidden field of the form, the form included with the request from the client having fields populated with user specified information.

16. The at least one computer-readable storage medium of claim 13, wherein the form is expressed in a markup language.

17. The at least one computer-readable storage medium of claim 13, further comprising:
receiving a second request from the client browser during a second secure session with the server after terminating the first secure session;
generating a second cryptographic nonce;
inserting the second cryptographic nonce into a hidden field of a resource included in a response sent by the server to the client;
receiving the resource from the client in a third request from the client browser;
analyzing the third request to determine if a second hidden cryptographic nonce is present therein and matches the second cryptographic nonce; and
fulfilling the third request only if the second hidden cryptographic nonce is present therein and matches the second cryptographic nonce that is included in the response sent by the server to the client.

18. The at least one computer-readable storage medium of claim 13, further comprising denying to process the request if the hidden cryptographic nonce is not present in the request or does not match the previously generated cryptographic nonce.

19. The at least one computer-readable storage medium of claim 18, further comprising redirecting the client browser to a login page if the request is denied.

20. The at least one computer-readable storage medium of claim 13, wherein the hidden cryptographic nonce that is generated is valid only during a single session between the server and the client.
